(19) United States
(12) Patent Application Publication
(10) Pub. No.: US 2024/0223583 A1
(43) Pub. Date: Jul. 4, 2024

(54) Methods and Apparatus for Network Control

(71) Applicant: Telefonaktiebolaget LM Ericsson (publ), Stockholm (SE)

(72) Inventors: Federico Pasini, Cogoleto (Genova) (IT); Maurizio Pighetti, Genova (IT); Daniele Ceccarelli, Sollentuna (SE)

(21) Appl. No.: 18/563,718

(22) PCT Filed: Jun. 24, 2021
(86) PCT No.: PCT/EP2021/067281

§ 371 Date: Nov. 22, 2023

(51) Int. Cl. H04L 9/40

(52) U.S. Cl. CPC H04L 63/1416; H04L 63/20

(57) ABSTRACT

Aspects of embodiments provide methods and network controllers for routing packets of data traffic in software defined networks (SDN). A method comprises obtaining, by a network controller for each of a plurality of network devices of the SDN, a security metric value; and determining, by the network controller, a route for the packet in the SDN based on the obtained security metric values for the plurality of network devices. The security metric value of each network device is calculated based on security characteristics of at least one of: a configuration of the network device; a virtual Network Function (vNF) or containerised Network Function (cNF) hosting a network device software instance; and a cloud infrastructure configuration supporting the vNF or cNF hosting the network device.

### TECHNICAL FIELD

Embodiments of the present disclosure relate to methods and apparatus for network control, and particularly methods and apparatus for packet routing in Software Defined Networks (SDN).

### BACKGROUND

Recent developments in telecommunication network technology have allowed increased separation between the control of physical network infrastructure and logical networks. Logical networks are a form of Software Defined Networks (SDN), and may also be referred to as virtual networks. SDNs essentially decouple the network control functions (the control plane) from the data forwarding functions (the data plane), introducing a degree of separation between control of the physical components forming the network infrastructure (nodes, cables, etc.) and the overall network control. In SDN, data transfer services can be used to provide a user with a data connection between two points, without requiring the user to have detailed knowledge of exactly which components of the network are responsible for providing the connection. As such, a data transfer service can be used to satisfy the data traffic requirements of a user, such as transferring a given volume of data traffic between two points at a given rate, with a given reliability, and so on.

SDNs support several advances relative to more traditional networks. By separating the control plane from the data plane in network devices (like switches and routers), SDNs allow the use of a centralized controller to determine the behaviour of all forwarding components in the network. SDNs typically use centralized network topologies, and thereby support intelligent control and management of network resources. The centralized control that may be facilitated by SDNs may provide improved bandwidth management, connection restoration and compliance with policies. Typically, data is routed through a SDN by setting bounds on parameters such as the number of hops used, packet loss and delay, and also taking into account other parameters such as available bandwidth, link administrative cost, and so on.

FIG. 1 is a schematic overview of a SDN layer architecture, adapted from FIG. 1 of “Software-Defined Networking (SDN): Layers and Architecture Terminology” IETF RFC 7426 by Haleplidis, E. et al., available at https://tools.ietf.org/html/rfc7426 as of 29 Apr. 2021. “Software-Defined Networking (SDN): Layers and Architecture Terminology” provides an overview of SDL layer structure and the interfaces between layers.

As can be seen in FIG. 1, the Control Plane (CP) southbound interface permits communication between the control plane and the forwarding plane (also referred to as the data plane), thereby supporting communications between the network controller and physical network hardware. Equally, northbound interfaces allow networking programmability, such as creating applications that can automate all networking tasks. The CP is responsible for making decisions on how packets should be forwarded by one or more network devices (such as routers and switches) and pushing such decisions down to the network devices for execution. The Management Plane (MP) is responsible for monitoring, configuring, and maintaining network devices, e.g., making decisions regarding the state of a network device.

The configuration shown in FIG. 1 can be contrasted to non-software defined networks, in which the control and data planes are typically integrated into a single software block (often proprietary code distributed by a proprietary vendor), which can prevents the network controller from obtaining info regarding physician network hardware. Separate sourcing of control and data functions allows network controllers to obtain more information about the status of the network, and therefore to provide more accurate control of network devices.

Although SDNs can provide advantages relative to non-SDN, such as the advantages discussed above, SDNs can be subject to security risks. Various types of security threat exist in SDN environments, examples include: Denial of Service (DoS) or Distributed Denial of Service (DDoS) attacks, in which a hostile party submits a large number of requests to a network controller causing it to become overloaded; attacks on communications between planes or within planes such as eavesdropping attacks, man-in-the-middle attacks or black-hole attacks; hijacked or rogue controller attacks in which a network controller that is under the control of a hostile party enters the network; and do on. These and other security threats can result in issues such as data leaking from the network and being obtained by hostile parties, the operation of the network becoming compromised, ongoing monitoring of data traffic by hostile parties, and so on.

### SUMMARY

It is an object of the present disclosure to provide improved security for SDNs. In particular, it is an object of the present disclosure to provide a system for routing data traffic in a SDN that more fully takes into consideration security concerns.

The summary is provided to introduce a selection of concepts in a simplified form that are further described below in the detailed description. The summary is not intended to identify key features or essential features of the claimed subject matter, nor is it intended to be used to limit the scope of the claimed subject matter. For the avoidance of doubt, the scope of the claimed subject matter is defined by the claims.

Embodiments of the disclosure aim to provide methods and apparatus that alleviate some or all of the problems identified herein.

An aspect of the disclosure provides a method for routing a packet of data traffic in a Software Defined Network (SDN). The method comprises obtaining, by a network controller for each of a plurality of network devices of the SDN, a security metric value; and determining, by the network controller, a route for the packet in the SDN based on the obtained security metric values for the plurality of network devices. The security metric value of each network device is calculated based on security characteristics of at least one of: a configuration of the network device; a virtual Network Function (vNF) or containerised Network Function (cNF) hosting a network device software instance; and a cloud infrastructure configuration supporting the vNF or cNF hosting the network device. By allowing the network controller to take into account a range of security characteristics of the network devices when plotting routes for packets, the method allows routing strategies that can protect high priority/sensitivity data from potentially low security routes, thereby reducing the chances of the data being interfered with or obtained by a hostile party. The use of a single security metric to represent each network device in some aspects of embodiments allows packet routing to be efficiently performed.

In some aspects, the security metric value for each of the plurality of network devices may be calculated by a Network Management System (NMS) and the network controller may receive the calculated security metric values from the NMS. In particular, the security metric values may be calculated by a Network Security Module (NSM) of the NMS. Utilisation of a specialised NSM to calculate the security metric values may provide an efficient means for implementing aspects of the disclosure.

In some aspects, the security metric value for each of the plurality of network devices may be calculated using network device information obtained from a network device database and/or using network device information obtained from the network devices, and the security metric value for a given network device may be recalculated if the network device information for that network device is updated. By dynamically updating the security metric values when network device information changes, aspects of the disclosure may ensure that packets can be securely routed based on accurate security information.

In some aspects, if no security characteristics information is available in relation to a particular security characteristic in relation to a network device among the plurality of network devices, a default value may be used for that security characteristic in relation to the network device among the plurality of network devices when obtaining the security metric values. In this way, the network devices for which the security characteristics information is available may be accurately evaluated, while still allowing comparisons to be made with the one or more network devices for which the security characteristics information is not available.

A further aspect of the disclosure provides a network controller configured to route a packet of data traffic in a SDN, the network controller comprising processing circuitry and a memory containing instructions executable by the processing circuitry, whereby the network controller is operable to obtain, for each of a plurality of network devices of the SDN, a security metric value. The network controller is further operable to determine a route for the packet in the SDN based on the obtained security metric values for the plurality of network devices. The security metric value of each network device is calculated based on security characteristics of at least one of: a configuration of the network device; a vNF or cNF hosting a network device software instance; and a cloud infrastructure configuration supporting the vNF or cNF hosting the network device. The network controller may provide some or all of the advantages discussed above and elsewhere in the disclosure in relation to the methods provided.

A further aspect of the disclosure provides a method for calculating a security metric value for each of a plurality of network devices, the security metric value for each of the plurality of network devices being for routing a packet of data traffic in a SDN. The method comprises obtaining security characteristics of each of the plurality of network devices, and calculating security metric values for each of the plurality of network devices using the security characteristics. The method further comprises initiating transmission of the calculated security metric values to a network controller. The security metric value of each network device is calculated based on security characteristics of at least one of: a configuration of the network device; a virtual Network Function, vNF, or containerised Network Function, cNF, hosting a network device software instance; and a cloud infrastructure configuration supporting the vNF or cNF hosting the network device. The method calculates a single security metric to represent each network device, allowing packet routing to be efficiently performed.

A further aspect of the disclosure provides a NMS configured to calculate a security metric value for each of a plurality of network devices, the security metric value for each of the plurality of network devices being for routing a packet of data traffic in a SDN. The NMS comprises processing circuitry and a memory containing instructions executable by the processing circuitry. The NMS is operable to obtain security characteristics of each of the plurality of network devices, and calculate security metric values for each of the plurality of network devices using the security characteristics. The NMS is further operable to initiate transmission of the calculated security metric values to a network controller. The security metric value of each network device is calculated based on security characteristics of at least one of: a configuration of the network device; a virtual Network Function, vNF, or containerised Network Function, cNF, hosting a network device software instance; and a cloud infrastructure configuration supporting the vNF or cNF hosting the network device. The NMS may provide some or all of the advantages discussed above and elsewhere in the disclosure in relation to the methods provided.

Further aspects provide systems and computer-readable media comprising instructions for performing the methods set out above.

### BRIEF DESCRIPTION OF DRAWINGS

For a better understanding of the present disclosure, and to show how it may be put into effect, reference will now be made, by way of example only, to the accompanying drawings, in which:

FIG. 1 is a is a schematic overview of a SDN layer architecture;

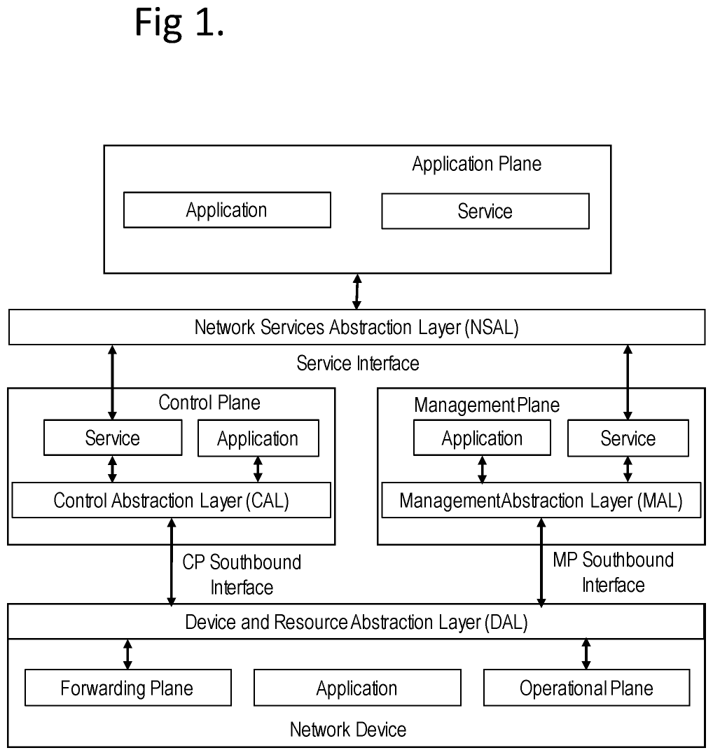

FIG. 2 is a flowchart of a method in accordance with embodiments;

FIG. 3A is a schematic diagram of a network controller in accordance with embodiments;

FIG. 3B is a schematic diagram of a further network controller in accordance with embodiments;

FIG. 4A is a schematic diagram of a network management system in accordance with embodiments;

FIG. 4B is a schematic diagram of a further network management system in accordance with embodiments;

FIG. 5A is a schematic diagram illustrating the calculation of security metric values; and

FIG. 5B is a schematic diagram illustrating the use of security metric values.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

Existing SDNs may support the collection of security information for network devices. Examples of the information which may be collected include network device configuration integrity, security log checks, cypher quality checks and certification checks.

Network device configurations are typically provided by a network operator (via a management system). A malicious attack on the network device may change something in the network device configuration (outside of the control of the network operator).

Following this change, the network device may still able to operate, but may be running a different configuration which may have security issues (for example, the network device may allow data access for a hostile party). A configuration integrity check can be used to ensure a configuration being run by network device is as specified by database in management system, that is, the configuration has not been modified by another party.

Security logs containing records of access attempts to network devices within a SDN may be maintained by the network devices themselves, or by other entities within the SDN. Reviews of these security logs may reveal unauthorised attempts to access network devices, which may be indicative of various security issues such as attempts to alter network device configurations, theft of data, and so on.

Typically, components within SDNs will support one or more security cyphers, which may be used to encrypt data and may therefore provide a degree of protection from security threats. The quality of the cyphers support may vary between network devices within a SDN; more complex and robust cyphers may require capabilities (such as processing capabilities) which are not possessed by all network devices within a SDN. A review of the one or more cyphers supported by a network device may therefore be used to determine the level of security of the network device interfaces.

A further measure of the security of a network device may be obtained through a review of any security certification possessed by the network device. As an example of this, a network device may use a certificate for Transport Layer Security (TLS) connections, which may be a self-signed certificate or which may have been assigned by an external (to the network device) certification authority. In addition to the type of certificate possessed by a network device, a further relevant consideration is the status of the certificate, that is, whether the certificate is current or is revoked or expired.

In addition or alternatively to the above security information, additional security information may be available in scenarios where network devices operate as virtualized network functions (vNFs) or containerized network functions (cNFs) hosted on a cloud infrastructure. Where vNFs or cNFs are used, the security of the network device is determined not only by the network device specific measurements (as discussed above), but also by the security characteristics of the underlying cloud infrastructure. The cloud infrastructure may comprise cloud platform hosts or Virtual Machine (VM) Operating Systems (OS), containerization and orchestration platforms, and so on.

Typically network controllers used for routing data packets through SDNs do not have access to security information for network devices within the SDN, or for cloud infrastructure supporting network devices (where cloud infrastructure is used). Further, even in situations where some security information may be available to network controllers, typically this information is not taken into consideration by the SDNs when determining routing for data packets. Accordingly, existing systems for routing data traffic through SDNs are not capable of fully taking into consideration security concerns, and may simply calculate routing paths for data packets without consideration of security concerns.

Embodiments may provide improved security for SDNs, in particular, may provide systems for routing data traffic in a SDN that more fully take into consideration security concerns.

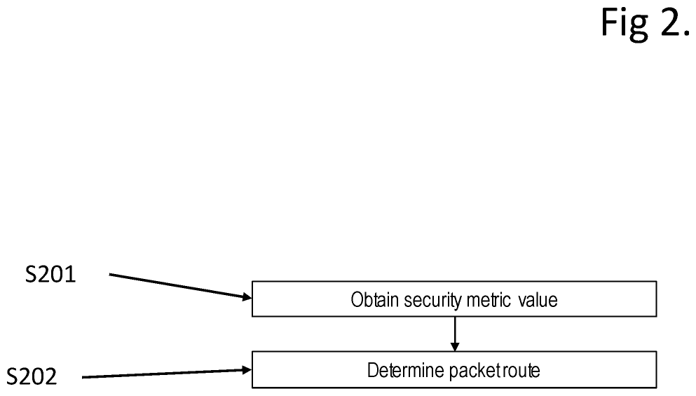

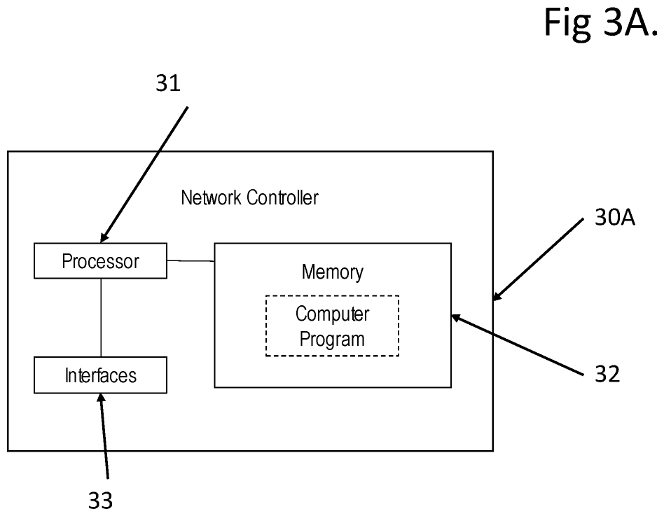

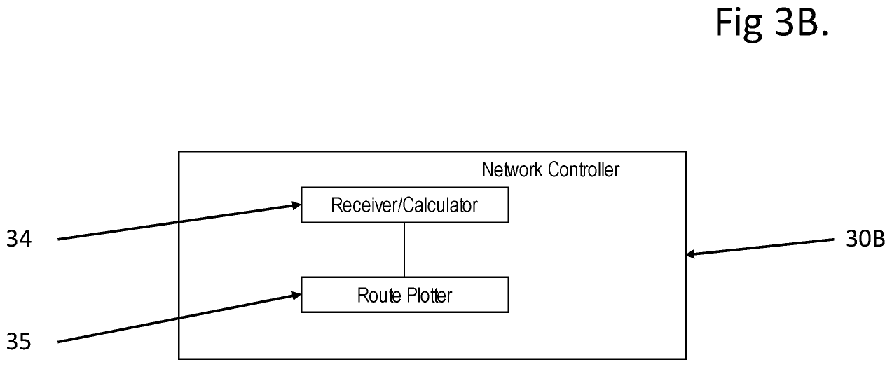

FIG. 2 is a flowchart of a method in accordance with embodiments. The method may be performed by any suitable apparatus. Examples of suitable apparatus for performing the method shown in FIG. 2 are the network controllers 30A and 40B shown schematically in FIG. 3A and FIG. 3B respectively; the network controllers 30A and 30B may collectively be referred to using reference sign 30. As discussed above, the method may also be performed by any other suitable component or components, such as a further network component. The network controller 30A as shown in FIG. 3A may execute steps of the method in accordance with a computer program stored in a memory 32, executed by a processor 31 in conjunction with one or more interfaces 33. The network controller 30B may execute steps of the method using receiver/calculator 34 and route plotter 35. The network controllers 30A and 40B may also be configured to execute the steps of other embodiments, as discussed in detail below.

As indicated in FIG. 2, in step S201 of the method the network controller 30 of a SDN obtains, for each of a plurality of network devices in the SDN, a security metric value. In particular, network controller 30A may obtain the security metric values in accordance with a computer program stored in a memory 32, executed by a processor 31 in conjunction with one or more interfaces 33. The network controller 30B may obtain the security metric values using receiver/calculator 34. The security metric value provides a measure of the security of each network device, and is calculated based on the security characteristics of at least one of: a configuration of the network device; a vNF or cNF hosting the network device software instance; and a cloud infrastructure configuration supporting a vNF or cNF hosting the network device. In some embodiments, the security metric values for the network devices in the SDN may be normalised, thereby providing information on the relative security levels of the respective network devices. Any suitable scale may be used to represent the security metric values, such as: a continuous numerical scale between 1 and 100, a discrete numerical scale between 1 and 10, a scale based on assigned letters (eg A=high security, E=low security), and so on. Typically although not exclusively, the same scale is used for all of the plurality of network devices. The security metric values of network devices may therefore be proportional to the secureness of the respective network devices.

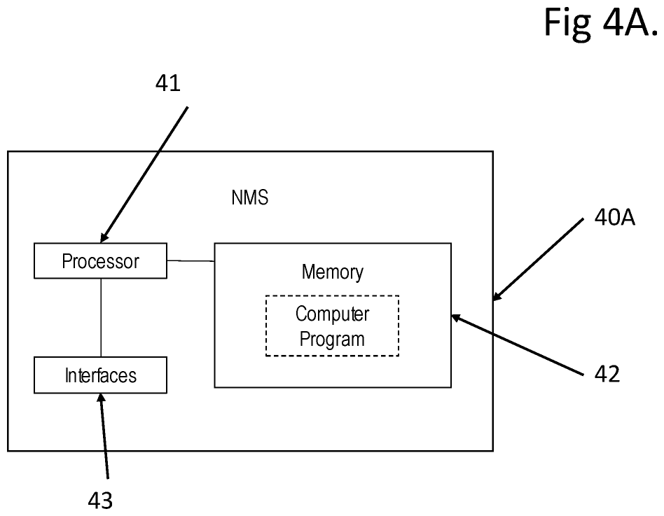

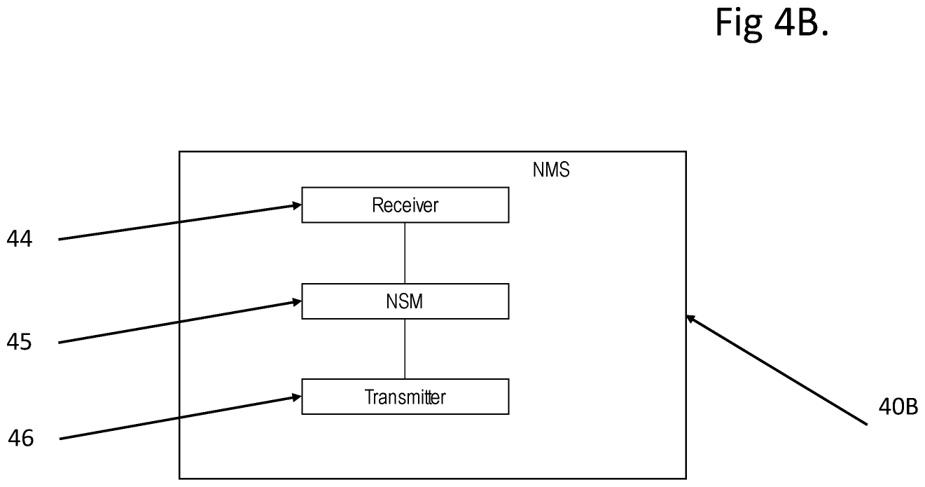

The security metric values may be calculated by the network controller 30, using information obtained by the network controller 30. Alternatively, the security metric values may be calculated by a Network Management System (NMS) and the network controller 30 may receive the calculated security metric values from the NMS. FIG. 4A and FIG. 4B are schematic diagrams of NMS 40A and 40B respectively (collectively referred to as NMS 40). The NMS 40A as shown in FIG. 4A may calculate the security metric values in accordance with a computer program stored in a memory 42, executed by a processor 41 in conjunction with one or more interfaces 43; the interfaces may be used to receive information allowing the NMS 40A to calculate the security metric values, and may also be used to transmit the calculated security metric values to a network controller. The NMS 40B may calculate the security metric values using receiver 44, Network Security Module (NSM) 45 and transmitter 46; in particular, the receiver 44 may be used to receive security characteristic information used to calculate the security metric values, the NSM 45 may be used to calculate the security metric values, and the transmitter 46 may be used to transmit the calculated security metric values (for example, to a network controller). One or both of the receiver 44 and transmitter 45 may be incorporated within a SDN Controller Module (SCM), which may be used to send to the SDN controller a security metric value for each network device. Also, the computer program stored in memory 42 may comprise a NSM, which may be used to calculate the security metric values when executed by processor 41. Where the security metric values are calculated by one or more components other than the network controller, the calculated security metric values may then be provided to the network controller.

The network device information used to calculate the security metric values for each of the network devices may be obtained from the network devices, for example, via transmission over the network or in another way. Alternatively, some or all of the network device information for some or all of the network devices among the plurality of network devices may be obtained from a network device database. The network device database may receive information relating to some or all of the plurality of network devices, and may store this information for use in calculating the security metric values. In some embodiments, the security metric value for a network device may be dynamically updated (recalculated) when the network device information for that network device is updated; where this is the case and a network device database is used, the network device database may notify the components responsible for calculating the security metric values (for example, a network controller, a NMS, a NSM, and so on) that the network device information has been updated and therefore a recalculation is required. In some embodiments, network security metric values for several network devices, potentially all of the plurality of network devices, may be recalculated when the network device information for one of the network devices is updated; this may be the case where, for example, it is necessary to renormalise the security metric values. Dynamic updating of the security metric values may ensure that packets can be routed through the network using up to date security information, and thereby can be routed using network devices providing an appropriate level of security.

The security metric value of each network device is calculated based on security characteristics of at least one of: a configuration of the network device; a virtual Network vNF or cNF hosting a network device software instance; and a cloud infrastructure configuration supporting a vNF or cNF hosting the network device. Where no security characteristics information is available in relation to a particular security characteristic (such as one of: a configuration of the network device; a virtual Network vNF or cNF hosting a network device software instance; and a cloud infrastructure configuration supporting a vNF or cNF hosting the network device) for one or more of the network devices among the plurality of network devices, a default value may be used for that particular security characteristic in relation to the one or more network devices when obtaining the security metric values. In this way, the network devices for which the security characteristics information is available may be accurately evaluated, while still allowing comparisons to be made with the one or more network devices for which the security characteristics information is not available. In some embodiments, the default value used for the particular security characteristic and network device combinations for which no security characteristics information is available may be an average (mean, modal or median) obtained using the security characteristics information for the same security characteristic from the network devices having said security characteristics information available.

As discussed above, the security metric value of each network device is calculated based on security characteristics of at least one of a configuration of the network device, a vNF or cNF hosting a network device software instance, and a cloud infrastructure configuration supporting a vNF or cNF hosting the network device. In some embodiments the security metric value of network devices may be calculated based on security characteristics of all of the configuration of the network device, vNF or cNF hosting the network device software instance, and cloud infrastructure configuration. In other embodiments, the security characteristics of only two or one of the configuration of the network device, vNF or cNF hosting the network device software instance, and cloud infrastructure configuration may be used in the calculation; this may be the case, for example, where neither a vNF or cNF, or any supporting cloud infrastructure is used. The security characteristics information used to calculate the security metric values is determined by the particular configuration and security priorities of a system implementing the routing methods discussed herein; a system may be configured to use only security characteristics relating to the configurations of network devices to calculate the security metric values for the network devices, even where other security characteristics information (such as that relating to vNFs or cNFs hosting network device software instances) is available.

The security characteristics of each of a configuration of a network device, a vNF or cNF hosting a network device software instance, and a cloud infrastructure configuration supporting a vNF or cNF hosting the network device may comprise information relating to a variety of different security properties.

The security characteristics of the configuration of the network device may comprise at least one of a configuration integrity of the network device, a quality of the security cyphers supported by the network device, and an origin and status of any network device security certification. The configuration integrity of the network device indicates whether or not a configuration being run by network device is as specified by database in management system, that is, the configuration is not suspected of having been modified by another party; clearly where the configuration is suspected of having been modified by another party this is a potential security risk and would result in the network device being considered less secure than the alternative. The quality of the cyphers supported by a network device provide a measure of the robustness of the network device when attempting to withstand attacks from hostile parties; lower quality cyphers would result in a network device being considered less secure than higher quality cyphers. The origin and status of any network device security certification (for example, certification used for TLS connections) provides a further measure of the network device security; network devices with no certification would typically be considered less secure than self certified devices, which in turn would be considered less secure than network devices having a certificate assigned by an external (to the network device) certification authority. In addition to the type of certificate possessed by a network device, a further relevant consideration is the status of the certificate, that is, whether the certificate is current or is revoked or expired (with current certificates being considered more secure than the other alternatives).

The security characteristics of a vNF or cNF hosting a network device software instance may comprise at least one of security protocols used by the vNF or cNF, data encryption and integrity checking used by the vNF or cNF, an origin and status of any security certification used by the vNF or cNF, and information from analysis of the vNF or cNF security log files. More robust security protocols used by a vNF or cNF would result in the vNF or cNF being considered more secure than if less robust protocols were used; typically newer protocols have fewer known vulnerabilities and are therefore considered to be more robust. Similarly, more complex data encryption and thorough integrity checking used by the vNF or cNF would result in the vNF or cNF being considered more secure than if less complex data encryption and thorough integrity checking were used. The origin and status of any security certification used by the vNF or cNF would be considered similarly to network device security certification; vNF or cNF with no certification would typically be considered less secure than self certified vNF or cNF, which in turn would be considered less secure than vNF or cNF having a certificate assigned by an external certification authority. An analysis of vNF or cNF security log files may be used to determine any attempted but unsuccessful or successful unauthorised accesses to a virtual machine or container that is used to host the network device software instance; indications of either attempted or successful unauthorised accesses would result in the vNF or cNF being considered less secure (with successful unauthorised access being considered a greater security risk than attempted but unsuccessful attempts).

The security characteristics of a cloud infrastructure configuration supporting a vNF or cNF hosting a network device may comprise at least one of information from analysis of cloud infrastructure security log files, and results from benchmarking tests on the cloud infrastructure. The cloud infrastructure security log files may be considered in a similar way to vNF or cNF log files, with indications of either attempted or successful unauthorised accesses resulting in the cloud infrastructure being considered less secure (with successful unauthorised access being considered a greater security risk than attempted but unsuccessful attempts). The benchmarking tests on the cloud infrastructure may be standardised tests used to allow comparison between the security provided by different cloud infrastructures using a constant scale, with analyses of security measures used, risks due to 3^{rd} party applications using the cloud infrastructure, and so on. An example of suitable benchmarking tests are those provided by the Center for Internet Security (CIS), as discussed at https://www.cisecurity.org/cis-benchmarks/as of 5 May 2021.

Weighting factors may be applied to the different security characteristics used in calculating the security metric values for the network devices, depending on the relative importance of the different security characteristics to a system implementing the routing methods discussed herein. As an example of the use of weighting in an embodiment, with reference to the security characteristics of a vNF or cNF hosting a network device software instance; if the security characteristics of the network devices comprise security protocols used by the vNF or cNF and an origin and status of any security certification used by the vNF or cNF, and the security protocols are of more importance in the embodiment than the security certification, then a weighting factor of 75% may be used for the security protocols and 25% for the security certification.

Once all of the security characteristics have been determined (and any weighting factors applied if applicable), a single security metric value is obtained for each of the plurality of network devices. Ideally a security metric value is obtained for each network device used in the SDN, although the plurality of network devices may not encompass every network device used in the SDN. Further, and as explained above, in embodiments the security metric values are not fixed once determined; if the security characteristics of a network device change after the security metric value for that network device has been determined, the security metric value for the network device is dynamically recalculated. In embodiments, the security metric values for some or all of the plurality of network devices (where the plurality of network devices may be some or all of the network devices used by the SDN) may be dynamically recalculated when the security characteristics of at least one of the network devices changes.

When the security metric values for the have been obtained by the network controller (for example, either calculated by the network controller or received from a further component such as a NMS), the network controller then determines a route for the packet of data traffic based on the obtained security metric values for the plurality of network devices, as shown in step S202 of FIG. 2. In particular, network controller 30A may determine a route for the packet in accordance with a computer program stored in a memory 32, executed by a processor 31 in conjunction with one or more interfaces 33. The network controller 30B may determine a route for the packet using route plotter 35. The routing for a packet may take into consideration on the security level of the packet, for example, the data in the packet (whether the packet contains sensitive or confidential data), the priority level of the packet, and so on. Alternatively, the routing for a packet may be determined based on the network device security metrics without reference to the security level of the packet itself. Additional criteria may also be taken into account when determining the packet routing, such as the number of hops used, packet loss and delay available bandwidth, link administrative cost, and so on; the relative weighting of the security metric values and any further criteria when determining packet routing may be dependent on the specific priorities of a system implementing an embodiment.

The packet routing for a packet may comprise avoiding network devices in the SDN having a security metric value below a predetermined threshold value; a single predetermined threshold may be used by a network controller for all packets routed through a SDN. Alternatively, different thresholds may be used, where the threshold may be determined in part based on the security level of packets routed through the SDN. As an example of the use of different thresholds according to an embodiment; where a continuous numerical scale between 1 and 100 is used to represent the security metric values of the network devices (with 1 being the lowest security and 100 the highest security), low security level packets may be routed via any device having a security metric higher than 10, while high security level packets may be routed via any device having a security metric higher than 50.

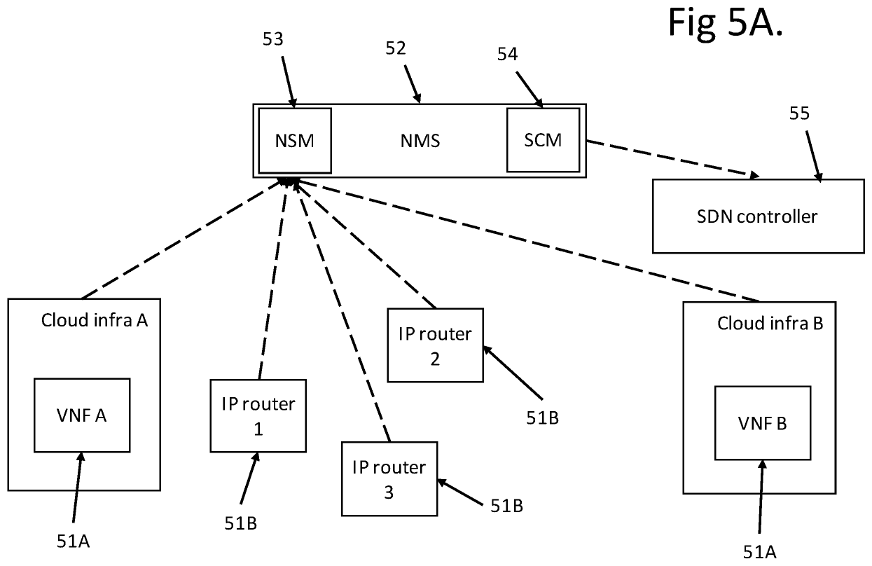

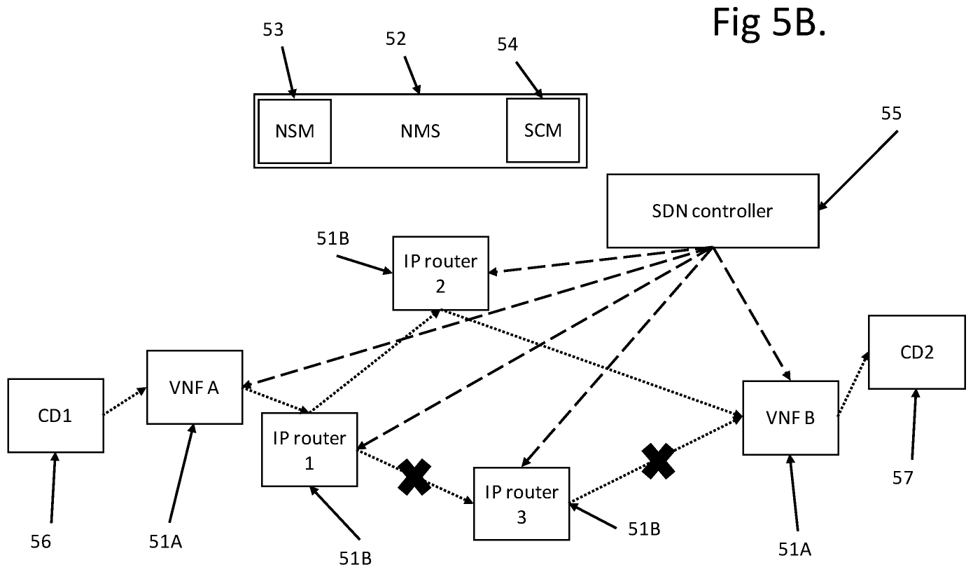

FIG. 5A and FIG. 5B (collectively FIG. 5) are schematic diagrams illustrating the calculation and use of the security metric values, in an embodiment. FIG. 5A illustrates the calculation of the security metric values, and FIG. 5B illustrates the use of the security metric values. For simplicity, FIG. 5 shows a small SDN with a limited number of routing options; typically SDNs would use larger numbers of network devices and routing options than are shown in FIG. 5.

In the embodiment shown in FIG. 5, a plurality of network devices 51 are used. The plurality of network devices 51 comprises network device software instances 51A hosted on vNFs supported by cloud infrastructure and also other network devices 51B not using vNFs or cNFs (in the FIG. 5 embodiment the other network devices are all IP routers). In the embodiment shown in FIG. 5, the plurality of network devices comprises all the network devices used by the SDN. As shown by the dashed arrows in FIG. 5A, each of the plurality of network devices 51 sends security characteristic information to a NMS 52, where the calculation of the security metric values is performed by a NSM 53 of the NMS 52. Following the calculation of the security metric values, the calculated security metric values are then sent by a SCM 54 of the NMS 52 to the SDN controller 55 (also indicated by a dashed arrow in FIG. 5A). The security metric values may then be used by the SDN controller to determine the routing of a packet through the network. The SDN controller 55 is an example of a network controller, and may be a network controller as shown in FIG. 3.

FIG. 5B shows the use of the security metric values in the routing of a packet. In addition to the components shown in FIG. 5A, FIG. 5B also shows two client devices (CD); CD1 56 and CD2 57. A packet is to be sent from CD1 to CD2 via the SDN. The SDN controller 55 uses the security metric values for the network devices 51 to plot the route of the packet. In the embodiment shown in FIG. 5, a single predetermined threshold is used to determine the route of a packet, in particular, network devices having a security metric value below the predetermined threshold value are avoided in the packet route. The SDN controller determines that all of VNF A, VNF B, IP router 1 and IP router 2 have security metric values above the predetermined threshold value, but that IP router 3 has a security metric value below the predetermined threshold value. The SDN controller then analyses the routing options for the packet (indicated by dotted arrows in FIG. 5B), and routes the packet through the SDN while avoiding IP router 3 (as indicated by the cross marks on the route options via IP router 3). Accordingly, a route for the packet through the SDN is determined based on the obtained security metric values of the plurality of network devices.

By allowing SDN packet routing to be determined using security metric values, embodiments allow packets to be routed via components using an appropriate level of security, for example, such that high priority packets or packets containing confidential information may be routed via network devices considered to be more secure. Accordingly, embodiments may reduce the risk of critical data being obtained by a hostile party, and may reduce the risk of performance degradation due to security attacks interfering with the performance of network devices, vNF/cNFs supporting network devices, or cloud infrastructure supporting network devices. By allowing security metric values to be dynamically recalculated when security characteristics are altered, embodiments may allow the routing of data to be continually updated as required to take into account up to date network device security information.

In general, the various exemplary embodiments may be implemented in hardware or special purpose circuits, software, logic or any combination thereof. For example, some embodiments may be implemented in hardware, while other embodiments may be implemented in firmware or software which may be executed by a controller, microprocessor or other computing device, although the disclosure is not limited thereto. While various exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1-36. (canceled)

37. A method performed by a network controller, the method comprising:
obtaining a security metric value for each of a plurality of network devices of a Software Defined Network (SDN);
determining a route for a packet of data traffic in the SDN based on the obtained security metric values for the plurality of network devices; and
transmitting the packet through the SDN using the determined route;
wherein the security metric value of each network device is calculated based on security characteristics of:
a configuration of the network device; and/or
a virtual Network Function (vNF) or containerized Network Function (cNF) hosting a network device software instance; and/or
a cloud infrastructure configuration supporting the vNF or cNF hosting the network device.

38. The method of claim 37, wherein:
the security metric value for each of the plurality of network devices is calculated by a Network Management System (NMS); and
the network controller receives the calculated security metric values from the NMS.

39. The method of claim 37, wherein the security metric value of each network device is proportional to the secureness of that network device.

40. The method of claim 37, wherein the security characteristics of the configuration of the network device comprise at least one of:
a configuration integrity of the network device;
a quality of the security cyphers supported by the network device;
an origin and status of any network device security certification.

41. The method of claim 37, wherein the security characteristics of a vNF or cNF hosted on the network device comprise at least one of:
security protocols used by the vNF or cNF;
data encryption and integrity checking used by the vNF or cNF;
an origin and status of any security certification used by the vNF or cNF;
information from analysis of the vNF or cNF security log files.

42. The method of claim 37, wherein the security characteristics of the cloud infrastructure supporting the vNF or cNF on the network device comprise information from analysis of cloud infrastructure security log files and/or results from benchmarking tests on the cloud infrastructure.

43. The method of claim 37, wherein obtaining the security metric values for each of the network devices comprises normalizing the security characteristics.

44. The method of claim 37, further comprising, responsive to security characteristics information being unavailable for a particular security characteristic of a network device among the plurality of network devices, using a default value for that security characteristic of the network device when obtaining the security metric values.

45. The method of claim 37, wherein obtaining the security metric value for each of the plurality of network devices comprises applying weighting factors to security characteristics.

46. The method of claim 37, wherein determining the route for the packet in the SDN comprises avoiding network devices having a security metric value below a predetermined threshold value.

47. A network controller comprising:
processing circuitry and a memory containing instructions executable by the processing circuitry, whereby the network controller is configured to:
obtain, for each of a plurality of network devices of the SDN, a security metric value;
determine a route for a packet of data traffic in the SDN based on the obtained security metric values for the plurality of network devices; and
transmit the packet through the SDN using the determined route;
wherein the security metric value of each network device is calculated based on security characteristics of:
a configuration of the network device; and/or
a virtual Network Function (vNF) or containerized Network Function (cNF) hosting a network device software instance; and/or
a cloud infrastructure configuration supporting the vNF or cNF hosting the network device.

48. The network controller of claim 47, wherein:
the security metric value for each of the plurality of network devices is calculated by a Network Management System (NMS); and
the network controller is further configured to receive the calculated security metric values from the NMS.

49. The network controller of claim 47, wherein the security metric value of each network device is proportional to the secureness of that network device.

50. The network controller of claim 47, wherein the security characteristics of the configuration of the network device comprise at least one of:
a configuration integrity of the network device;
a quality of the security cyphers supported by the network device;
an origin and status of any network device security certification.

51. The network controller of claim 47, wherein the security characteristics of a vNF or cNF hosting the network device software instance comprise at least one of:
security protocols used by the vNF or cNF;
data encryption and integrity checking used by the vNF or cNF;
an origin and status of any security certification used by the vNF or cNF;
information from analysis of the vNF or cNF security log files.

52. The network controller of claim 47, wherein the security characteristics of the cloud infrastructure configuration supporting the vNF or cNF hosting the network device comprise information from analysis of cloud infrastructure security log files and/or results from benchmarking tests on the cloud infrastructure.

53. The network controller of claim 47, wherein to obtain the security metric values for each of the network devices, the network controller is configured to normalize the security characteristics.

54. The network controller of claim 47, further configured to, responsive to security characteristics information being unavailable for a particular security characteristic of a network device among the plurality of network devices, use a default value for that security characteristic of the network device among the plurality of network devices when obtaining the security metric values.

55. The network controller of claim 47, wherein to determine the route for the packet in the SDN the network controller is configured to avoid network devices having a security metric value below a predetermined threshold value.

56. A non-transitory computer readable medium storing a computer program product for controlling a network controller, the computer program product comprising software instructions that, when run on processing circuitry of the network controller, cause the network controller to:
obtain a security metric value for each of a plurality of network devices of a Software Defined Network (SDN);
determine a route for a packet of data traffic in the SDN based on the obtained security metric values for the plurality of network devices; and
transmit the packet through the SDN using the determined route;
wherein the security metric value of each network device is calculated based on security characteristics of:
a configuration of the network device; and/or
a virtual Network Function (vNF) or containerized Network Function (cNF) hosting a network device software instance; and/or
a cloud infrastructure configuration supporting the vNF or cNF hosting the network device.
